(19) United States
(12) Patent Application Publication
(10) Pub. No.: US 2008/0242787 A1
(43) Pub. Date: Oct. 2, 2008

(54) Eucryptite ceramic filler and insulating composite material containing the same

(75) Inventors: Jin-Cheol Kim, Hwaseong-si (KR); Jun-Rok Oh, Seoul (KR); Geum-Hee Yun, Yongin-si (KR); Hwa-Young Lee, Suwon-si (KR); Tae-Koung Kim, Suwon-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/010,019

(22) Filed: Jan. 18, 2008

(30) Foreign Application Priority Data
Mar. 30, 2007 (KR) 10-2007-0031894

(51) Int. Cl. C08K 3/34

(52) U.S. Cl. 524/450

(57) ABSTRACT

The present invention relates a eucryptite ceramic filler and an insulating composite material containing the eucryptite ceramic filler. In particular, the invention provides a eucryptite ceramic filler of formula (I):

xLiO₂-yAl₂O₃-zSiO₂ (I)
wherein x, y and z represent a molar ratio, x and y are each independently from 0.9 to 1.1, and z is from 1.9 to 2.1; and the eucryptite ceramic filler is used to reduce a coefficient of thermal expansion of an insulating composite material.

### CROSS-REFERENCE TO RELATED APPLICATION

This application claims the benefit of Korean Patent Application No. 10-2007-0031894 filed with the Korean Intellectual Property Office on Mar. 30, 2007, the disclosures of which is incorporated here by reference in its entirety.

### BACKGROUND

1. Technical Field

The present invention relates to a eucryptite ceramic filler and an insulating composite material containing the eucryptite ceramic filler.

2. Description of the Related Art

Recently, in response to the trend for electronic devices with greater miniaturization, there is a great demand for a printed circuit board which is a main part of the electronic devices. Also, it has been required that the printed circuit board should be in small size and have a high density. The printed circuit board is used to make connections between active ICs or between the ICs and passive components. Further, the printed circuit board serves to fix the IC so that it operates well under conditions of use of IC.

Accordingly, there is a need to maintain electrical, mechanical and chemical stability of the printed circuit board. Dimensional deformation by heat of the board may cause the destruction of board or IC; electrical open circuit; or short circuit etc., when the board is fabricated, an electronic component such as an IC is mounted on the board, or an apparatus is operated under certain conditions. Especially, with the appearance of low-k dielectrics, it accelerates fabricating thin and high density boards. Also, there is a need for 3-dimensional packaging technologies currently. Thus, an insulating material with a low coefficient of thermal expansion (CTE) becomes an essential item for the electronics field.

The board is mainly composed of an insulating layer and Cu. It is preferable to use an insulating layer whose coefficient of thermal expansion is same as that of Cu so that it can eliminate delamination by reducing a residual stress after the fabrication of boards. However, the coefficient of thermal expansion of Cu is 17 ppm/° C., whereas the insulating layer has a coefficient of thermal expansion much higher than that of Cu since the insulating layer is mainly composed of a polymer. To reduce the coefficient of thermal expansion of the insulating material of the board, such methods as changing a type and an amount of resin and adding a woven glass fiber or a ceramic filler is being used.

The coefficient of thermal expansion may be reduced by controlling a degree of cure and/or a degree of crosslink of resin. In case of the woven glass fiber, when a type of E-glass, currently being used, is changed with a type of S (or T)-glass, the coefficient of thermal expansion of the board may be reduced. However, in the case with use of S-glass, if pitches between vias or through holes are decreased, a glass break occurs during a drilling process, which further causes a short between via and via or between through hole and through hole due to seeping of plating liquid during a plating process.

An easy method for reducing the coefficient of thermal expansion is to increase an amount of filler, which is cost effective. However, this method has some problems of drill wear in a drilling process and resulting residues from a laser processing, which causes not only increases in manufacturing cost but also high defective rate. Also, it may deteriorate an adhesive strength between the insulating material and the Cu.

### SUMMARY

The invention is to solve the problems associated with the conventional technologies. An aspect of the invention is to provide a eucryptite ceramic filler, which may efficiently reduce a coefficient of thermal expansion of an insulating composite material without increasing an amount of a ceramic filler, compared with an existing filler.

Another aspect of the invention is to provide an insulating composite material containing the eucryptite ceramic filler.

One aspect of the invention provides a eucryptite ceramic filler of formula (I):

xLiO₂-yAl₂O₃-zSiO₂ (I)

wherein x, y and z represent a molar ratio, x and y are each independently from 0.9 to 1.1, and z is from 1.9 to 2.1; and

the eucryptite ceramic filler is used to reduce a coefficient of thermal expansion of an insulating composite material.

The insulating composite material may be used to at least one material selected from the group consisting of an insulating material for a printed circuit board, an epoxy molding compound, a solder mask and a plugging ink.

In one embodiment of the invention, wherein x is 1, y is 1 and z is 2.

In one embodiment of the invention, the particle size of the filler may be from about 0.1 to about 5 μm.

In one embodiment of the invention, the coefficient of thermal expansion of the filler may be from about −9 to about −2 ppm/° C.

In one embodiment of the invention, the filler may be synthesized at a temperature of about 1000 to about 1400° C.

Another aspect of the invention provides an insulating composite material including:

about 30 to about 80 wt % of a thermosetting resin; and

about 20 to about 70 wt % of a eucryptite ceramic filler of formula (I);

xLiO₂-yAl₂O₃-zSiO₂ (I)

wherein x, y and z represent a molar ratio, x and y are each independently from 0.9 to 1.1, and z is from 1.9 to 2.1.

In one embodiment of the invention, the insulating composite material may be used to at least one selected from the group consisting of an insulating material for printed circuit board, an epoxy molding compound, a solder mask and a plugging ink.

In one embodiment of the invention, the insulating composite material may further include a reinforcement material. The reinforcement material may be at least one selected from the group consisting of a woven glass fiber, an organic fiber, an inorganic fiber and organic/inorganic hybrid fiber.

In one embodiment of the invention, wherein x is 1, y is 1 and z is 2.

### BRIEF DESCRIPTION OF THE DRAWINGS

FIG. 1 is an X-ray diffraction (XRD) graph of a eucryptite ceramic filler prepared in Preparation Example 1.

FIG. 2 is an XRD graph of a eucryptite ceramic filler prepared in Preparation Example 4.

FIG. 3 is a graph showing dimensional changes against a temperature of eucryptite ceramic fillers prepared in Preparation Examples 1 to 4.

FIG. 4 is a graph showing dimensional changes against a temperature of insulating materials for printed circuit board prepared in Examples 2 and 4, and Comparative Examples 1 and 2.

### DETAILED DESCRIPTION

In the following, the present invention is described in detail with reference to the accompanying drawings.

A filler such as a fused silica has used to reduce a coefficient of thermal expansion of an insulating composite material such as an insulating material for printed circuit board, an epoxy molding compound, a solder mask and a plugging ink and so on. The fused silica has a coefficient of thermal expansion of about +5 ppm/° C. When the fused silica is mixed with an insulating polymer, such as an epoxy, the coefficient of thermal expansion of the mixture has been able to be reduced according to a mixed volume. Both the insulating polymer and the fused silica have a positive coefficient of thermal expansion. The coefficient of thermal expansion of the insulating material can be reduced depending on whether each of the values of coefficient of thermal expansion of the insulating polymer and the fused silica is large or small, i.e. a mixing rule.

A eucryptite ceramic filler according to the invention has a negative coefficient of thermal expansion, which can further reduce the coefficient of thermal expansion of the insulating composite material efficiently.

One aspect of the invention provides a eucryptite ceramic filler of formula (I):

xLiO₂-yAl₂O₃-zSiO₂ (I)

wherein x, y and z represent a molar ratio, x and y are each independently from 0.9 to 1.1, and z is from 1.9 to 2.1.

The eucryptite ceramic filler is a crystallized glass composed of LiO₂, Al₂O₃, and SiO₂ components. In x, y and z, which represent a molar ratio, x and y are each independently from 0.9 to 1.1, and z is from 1.9 to 2.1. When the x, y and z are within these ranges, a crystal structure of eucryptite, LiAlSiO₄, with the lowest coefficient of thermal expansion can be synthesized. However, if the x, y and z are beyond these ranges, different crystal structures with another phase such as LiAlO₂ and Li₂SiO₃, whose coefficient of thermal expansion are higher than that of LiAlSiO₄ structure, increase. Thus, there may be a problem that the final eucryptite ceramic filler with increased coefficient of thermal expansion is obtained. According to one embodiment, it is preferable that x is 1, y is 1 and z is 2.

The eucryptite ceramic filler is prepared with each of the oxide components of LiO₂, Al₂O₃, and SiO₂ by a method of powder synthesis well known in the field of art. In one embodiment of the invention, the oxides are mixed together at a molar ratio as described in the formula (I), and then the mixture is treated by heat at a specific temperature to synthesize a eucryptite ceramic filler. In one embodiment of the invention, it is preferable that a single phase of eucryptite is prepared by mixing the oxides and heating the mixture at a temperature of between about 1000 and about 1400° C.

As the heating temperature increases, purity of the crystal structure of LiAlSiO₄ is increased and reduces different crystal structures with another phase such as LiAlO₂ and Li₂SiO₃ etc. As a result, a eucryptite ceramic filler with a low coefficient of thermal expansion may be prepared. If the heating temperature is less than 1000° C., it is difficult to achieve eucryptite phase formation so that a negative coefficient of thermal expansion is not obtained. On the other hand, if the heating temperature is higher than 1400° C., there may be a problem that part of the oxide components melts to form a glass, or that it is to difficult to grind the eucryptite ceramic filler.

The eucryptite ceramic filler of the inventions has a coefficient of thermal expansion ranging from about −9 to about −2 ppm/° C.

Further, when the eucryptite ceramic filler mixes with a thermosetting resin to reduce the coefficient of thermal expansion of the insulating material for printed circuit board, the particle size of the filler may be from about 0.1 to about 5 μm. If the particle size is beyond the range, it deteriorates the filler properties, or lowers insulation of the board.

The eucryptite ceramic filler of the inventions has a negative coefficient of thermal expansion, which is different from the existing fused silica. Hence, it is possible to reduce the coefficient of thermal expansion of an insulating composite material efficiently with the eucryptite ceramic filler of the invention, without changing types of resins or without increasing an amount of filler.

The insulating composite material may be used to various materials such as an insulating material for printed circuit board, an epoxy molding compound, a solder mask and a plugging ink etc., but the invention is not thus limited.

Another aspect of the invention provides an insulating composite material including:

about 30 to about 80 wt % of a thermosetting resin; and

about 20 to about 70 wt % of a eucryptite ceramic filler of formula (I);

xLiO₂-yAl₂O₃-zSiO₂ (I)

wherein x, y and z represent a molar ratio, x and y are each independently ranging from 0.9 to 1.1, and z is ranging from 1.9 to 2.1.

The thermosetting resin for insulating composite material of the inventions may be any resin used in insulating materials. Examples of the thermosetting resins may include, but not limited to, an epoxy resin, a phenol resin, and an isocyanate resin and the like. In certain embodiments of the invention, the thermosetting resin can be used alone, or in combination thereof. The above-mentioned resins have a thermal resistance, good mechanical strength and insulation properties, so that the resin is being broadly used as insulating layers for boards.

A eucryptite ceramic filler used in the insulating composite material is described above. The eucryptite ceramic filler is synthesized at a temperature of between about 1000 and about 1400° C., and that the particle size of the filler is from about 0.1 to about 5 μm. Also, in one embodiment of the invention, it is preferable that x is 1, y is 1 and z is 2 in the formula (I).

In certain embodiments of the invention, the insulating composite material may include about 30 to about 80 wt % of a thermosetting resin; and about 20 to about 70 wt % of a eucryptite ceramic filler of formula (I). If the ceramic filler content is less than 20 wt %, or the thermosetting resin exceeds 80 wt %, it is difficult to reduce the coefficient of thermal expansion efficiently. Besides, there may be problems of deformation of the boards and/or crack occurrence in the boards. If the ceramic filler content exceeds 70 wt %, or the thermosetting resin is less than 30 wt %, fluidity of the insulating composite material may be deteriorated. Moreover, it is difficult to make the integration with the line patterns and mounted parts of IC.

In certain embodiments of the invention, the insulating composite material may further include a reinforcement material in order to improve the mechanical strength and processing property. Examples of reinforcement materials may be at least one selected from the group consisting of a woven glass fiber, an organic fiber, an inorganic fiber and an organic/inorganic hybrid fiber. Among them, the woven glass fiber is more preferable considering a thermal conduction rate, cost and convenience of making the boards.

In certain embodiments of the invention, the insulating composite material is prepared in the method of measuring raw materials and mixing them. A mixing may be achieved by using an apparatus such as a ball mill, a planetary mixer, or a stirrer.

The resulting insulating composite material may be used in insulating materials such as an insulating material for printed circuit board, an epoxy molding compound, a solder mask and a plugging ink and so on, but is not thus limited.

In certain embodiments of the invention, the insulating composite material has a lower coefficient of thermal expansion than that of the existing polymer/ceramic composites including the fused silica. Therefore, the insulating composite material of the invention may be used as insulating materials having good mechanical and thermal stability.

The invention may be better understood by referring to the following examples which are intended for illustrative purposes only and are not to be construed in any way as limiting the scope of the present invention, which is defined in the claims appended hereto.

### EXAMPLES

### Preparation Examples 1 to 4

### Synthesis of a Eucryptite Ceramic Filler

LiO₂, Al₂O₃, and SiO₂ as starting materials were mixed in a 1:1:2 molar ratio, followed by heat treatment at temperatures of 1000° C. (Preparation Example 1), 1100° C. (Preparation Example 2), 1200° C. (Preparation Example 3) and 1300° C. (Preparation Example 1), respectively, for 2 hours. Then single phase eucryptite was synthesized.

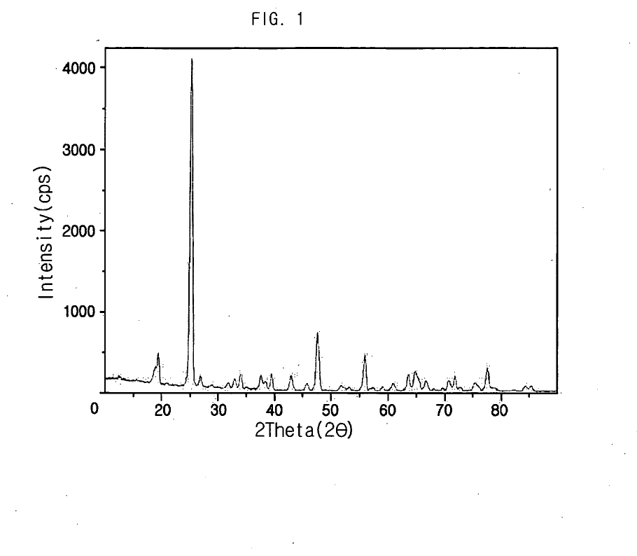

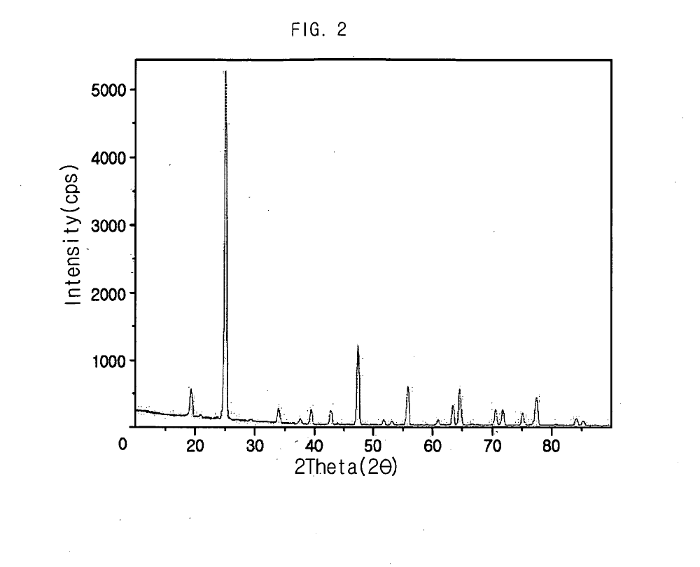

FIGS. 1 and 2 show X-ray diffraction patterns of the eucryptite ceramic according to Preparation Examples 1 and 4, respectively. As shown in FIGS. 1 and 2, it is noted that the eucryptite ceramic filler of the invention represent a crystal structure of LiAlSiO₄. However, it is presumed that FIG. 1 is a little different from FIG. 2 in view of the X-ray diffraction pattern since different phases such as LiAlO₂ and Li₂SiO₃ are present in Preparation Example 1.

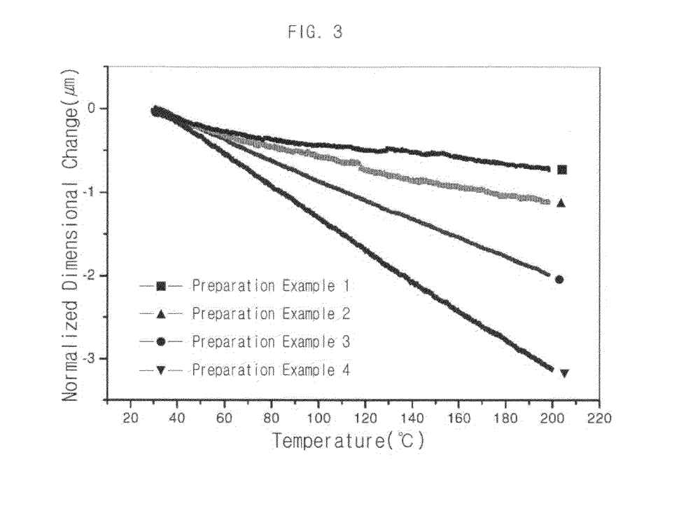

Normalized dimensional changes of Preparation Examples 1 are shown in FIG. 3, and coefficients of thermal expansion of Preparation Examples 1 to 4 are listed in Table 1.

TABLE 1

| | Preparation Example | | | |
|---|---|---|---|---|
| Catagory | 1 | 2 | 3 | 4 |
| heat treatment temperature (° C.) | 1000 | 1100 | 1200 | 1300 |
| coefficient of thermal expansion | −2.0 | −3.1 | −5.5 | −8.7 |
| (CTE, ppm/° C.) | | | | |

Referring to FIG. 3 and Table 1, the eucryptite ceramic filler of the invention has a negative coefficient of thermal expansion. Besides, it can be seen that the higher heat treatment temperature (i.e. synthesis temperature) is, the larger negative coefficient of thermal expansion value represents.

### Example 1

An epoxy resin was mixed with 8 wt % of the eucryptite ceramic filler synthesized in Preparation Example 1 (CTE=−2 ppm/° C.). Then, an insulating material for printed circuit board was prepared.

### Example 2

An epoxy resin was mixed with 26 wt % of the eucryptite ceramic filler synthesized in Preparation Example 1 (CTE=−2 ppm/° C.). Then, an insulating material for printed circuit board was prepared.

### Example 3

An epoxy resin was mixed with 10 wt % of the eucryptite ceramic filler prepared in Preparation Example 4 (CTE=−8.7 ppm/° C.). Then, an insulating material for printed circuit board was prepared.

### Example 4

An epoxy resin was mixed with 30 wt % of the eucryptite ceramic filler prepared in Preparation Example 4 (CTE=−8.7 ppm/° C.). Then, an insulating material for printed circuit board was prepared.

### Comparative Example 1

An insulating material for printed circuit board is prepared with an epoxy resin without adding a filler.

### Comparative Example 2

An epoxy resin was mixed with 34 wt % of a fused silica. Then, an insulating material for printed circuit board was prepared.

The coefficients of thermal expansion of the insulating materials according to Examples 1 to 4 are 60, 46, 55 and 35, respectively.

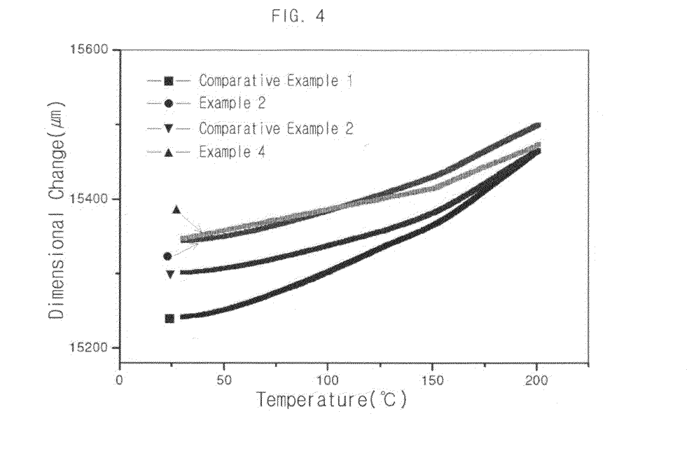

FIG. 4 shows dimensional changes against a temperature of insulating materials for printed circuit board prepared in Examples 2 and 4, and Comparative Examples 1 and 2. As shown in FIG. 4, the change in length and the coefficient of thermal expansion are smaller for the eucryptite ceramic filler of the invention than for the existing of fused silica.

Accordingly, it is seen that the eucryptite ceramic filler of the invention, which is used as the filler for the insulating material for the printed circuit board, can reduce the coefficient of thermal expansion of the insulating material efficiently without increasing the amount of the filler, compared with the existing fillers.

The present invention can be easily carried out by an ordinary skilled person in the art. Many modifications and changes may be deemed to be with the scope of the present invention as defined in the following claims.

What is claimed is:

1. A eucryptite ceramic filler of formula (I):
xLiO₂-yAl₂O₃-zSiO₂ (I)
wherein x, y and z represent a molar ratio, x and y are each independently from 0.9 to 1.1, and z is from 1.9 to 2.1; and
the eucryptite ceramic filler is used to reduce a coefficient of thermal expansion of an insulating composite material.

2. The eucryptite ceramic filler according to claim 1, the insulating composite material is used to at least one material selected from the group consisting of an insulating material for printed circuit board, an epoxy molding compound, a solder mask and a plugging ink.

3. The eucryptite ceramic filler according to claim 1, wherein x is 1, y is 1 and z is 2.

4. The eucryptite ceramic filler according to claim 1, wherein the particle size of the filler is from about 0.1 to about 5 g.

5. The eucryptite ceramic filler according to claim 1, wherein the coefficient of thermal expansion of the filler is from about −9 to about −2 ppm/° C.

6. The eucryptite ceramic filler according to claim 1, wherein the filler is synthesized at a temperature of between about 1000 to about 1400° C.

7. An insulating composite material comprising:
about 30 to about 80 wt % of a thermosetting resin; and
about 20 to about 70 wt % of a eucryptite ceramic filler of formula (I);
xLiO₂-yAl₂O₃-zSiO₂ (I)
wherein x, y and z represent a molar ratio, x and y are each independently from 0.9 to 1.1, and z is from 1.9 to 2.1.

8. The insulating composite material according to claim 7, the insulating composite material is used to at least one material selected from the group consisting of an insulating material for printed circuit board, an epoxy molding compound, a solder mask and a plugging ink.

9. The insulating composite material according to claim 7, further comprising a reinforcement material.

10. The insulating composite material according to claim 9, wherein the reinforcement material is at least one selected from the group consisting of a woven glass fiber, an organic fiber, an inorganic fiber and an organic/inorganic hybrid fiber.

11. The insulating composite material according to claim 7, wherein x is 1, y is 1 and z is 2.
